(19) United States
(12) Patent Application Publication
(10) Pub. No.: US 2025/0197085 A1
(43) Pub. Date: Jun. 19, 2025

(54) BAG WRAPS FOR PREPACKAGED FOODS AND OVEN COOKING

(71) Applicant: AFC PACKAGING L.L.C., LAKE IN THE HILLS, IL (US)

(72) Inventors: William James LEWIS, Naples, FL (US); William Christopher LEWIS, St. Charles, IL (US); Barton R. LEWIS, JR., Algonquin, IL (US)

(73) Assignee: AFC PACKAGING L.L.C., LAKE IN THE HILLS, IL (US)

(21) Appl. No.: 19/066,918

(22) Filed: Feb. 28, 2025

Related U.S. Application Data
(63) Continuation-in-part of application No. PCT/US2023/031854, filed on Sep. 1, 2023.
(60) Provisional application No. 63/403,073, filed on Sep. 1, 2022.

(51) Int. Cl. B65D 81/34

(52) U.S. Cl. CPC B65D 81/3461; B65D 2251/20

(57) ABSTRACT

A food product packaging for transport and/or cooking. The packaging includes a cooking bag of transpiring paper material to receive a food product to be cooked or heated. The cooking bag is exposed to the same heat source together with the food product. The food product and package can be placed into an electric oven or a microwave oven.

### CROSS REFERENCE TO RELATED APPLICATIONS

This application is a continuation-in-part of PCT Patent Application No. PCT/US2023/0031854, filed on 1 Sep. 2023, which claims the benefit of U.S. Provisional Patent Application 63/403,073. The co-pending parent application(s) is hereby incorporated by reference herein in its entirety and is made a part hereof, including but not limited to those portions which specifically appear hereinafter.

### FIELD OF THE INVENTION

This invention relates generally to packaging and/or cooking wrappings for food products and, more particularly, to a packaging and cooking bag for use in cooking food items in an oven.

### BACKGROUND OF THE INVENTION

Pre-packaged foods are in high demand due to the fast-paced life of today's workers. Food wrappings that can be placed within an oven are known, such as in U.S. Pat. No. 8,883,236, herein incorporated by reference. However, the stresses of packaging, transport, and handling, as well as the high temperatures of oven cooking are known to result in a high number of failures. There is a continuing need for improved packaging materials that can be used to cook food.

### SUMMARY OF THE INVENTION

A general object of the invention is to provide an improved paper-based food packaging that can be placed in the oven for cooking the food therein. The packaging of this invention provides a packaging solution that reduces or eliminates human touch of the food until opening of the package and consumption, or at least between cooking and consumption.

The general object of the invention can be attained, at least in part, through a package for a food product to be cooked or warmed. The package includes a paper bag formed of a transpiring paper material. The paper bag includes an open end to receive the food product. The open end is foldable, preferably the bag has a flap or is otherwise configured to fold over on itself to close the open end. A heat or pressure activated adhesive material is disposed in a strip on a side of the paper bag and configured to adhere to a folded portion of the paper bag.

In embodiments of this invention, the paper bag and the adhesive material are temperature resistant at cooking temperatures of over 520° F. (271° C.). The paper material desirably exhibits H₂O vapor permeability in a range of 5,000-15,000 cc H₂O/m²/about 24 h. The paper material is generally non-transparent, and the paper bag can include a transparent window configured to view the food product. The transparent window desirably has same or similar vapor permeability.

The adhesive material of embodiments of this invention is a heat settable acrylic adhesive, having a temperature rating, such as a SAT (Static Air Temperature) rating, of 600° F. The adhesive material is desirably printed on the bag side and dried, and the adhesive adheres the folded portion over the opening upon an application of heat, such as with pressure in a heated press tool. In other embodiments, the adhesive material is a pressure sensitive vinyl acetate adhesive, such as provided under a removeable liner strip. In some embodiments, the pressure sensitive adhesive strip is applied to the bag by a user when the food product is inserted into the paper bag. Desirably adhesive materials are all temperature resistant at cooking temperatures of over 520° F. (271° C.), water-based, and/or crosslinkable under heat and/or pressure.

The paper bag desirably includes a gusset fold longitudinally extending along each side panel. The gusset fold(s) allows the bag to fold flat before use, while also providing sufficient side support and internal spacing within the bag during cooking. The paper bag also desirably includes one or more fold lines along, and set back from, the opening to assist in folding and closing the open end. The fold line can be on a top side, and/or on a bottom side, and/or on the gusset sides.

In embodiments of this invention, the paper material comprises a moisture or grease resistant coating. Exemplary coatings include fluoropolymer coatings, but other suitable coatings can be used.

The invention further includes a packaged food preparation including a food item in any of the packaging described herein. The invention further includes a use of the packages described herein to transport and cook food.

The invention further includes a method of cooking or warming a food item. The method including placing the food product packaged in any package described herein into a heated oven, such as an electric oven or a microwave oven.

The invention further includes a continuous web of a plurality of packages of any package described herein. The continuous web can be used in a food packaging machine, or provided to an end user for individual separation when a package is needed. The plurality of packages are folded along a gusset side fold into a flattened orientation, to allow for transport and storage.

Other objects and advantages will be apparent to those skilled in the art from the following detailed description taken in conjunction with the appended claims and drawings.

### BRIEF DESCRIPTION OF THE DRAWINGS

FIG. 1 shows a perspective view of a paper-based cooking bag according to one embodiment of this invention.

FIGS. 2-5 show a paper-based cooking bag according to one embodiment of this invention.

FIGS. 6-7 show a use of a cooking bag according to one embodiment of this invention.

FIGS. 8 and 9 shows a paper-based cooking bag closure according to one embodiment of this invention.

FIG. 10 shows a perspective view of a paper-based cooking bag according to one embodiment of this invention.

### DETAILED DESCRIPTION OF THE INVENTION

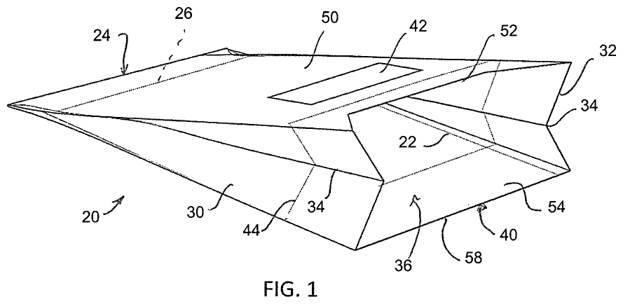

FIG. 1 shows a paper-based cooking bag 20 according to embodiments of this invention. The bag 20 is formed of one paper material piece, folded and sealed along longitudinal seal 22, and folded and sealed at one end 24 by end seal 26. The seals 22 and 26 can be any suitable temperature resistant adhesive, including the heat settable or pressure sensitive adhesives discussed herein.

The bag 20 includes two, opposing side panels 30 and 32. Each side panel 30, 32 includes a gusset fold 34 that allows the bag to lay flat (see e.g., FIG. 3). The gusset fold 34 desirably extends an entire longitudinal length of the bag 20. The gusset fold provide structural support for the interior cavity 36, and promotes an even air space within the cavity 36.

The bag 20 includes a second, open end 40, configured to receive a food item before sealing and cooking. The open end 40 is foldable back against adhesive strip 42 to close the bag 20 to enclose the food item for transport and/or cooking. One or more fold lines 44 can be included to assist the user and promote proper folding and adhering. The fold line 44 can be in one or more surfaces of the bag 20, and is shown as extending circumferentially about the bag, in all four sides. The fold line 44 can be any suitable structure, such as a score line or other line of weakness (e.g., perforations).

In the embodiment of FIG. 1, the top panel 50, including the adhesive strip 42, includes a recessed edge 52 along the opening end 40. The offset recessed edge 52 allows an inner surface 54 of the opposing bottom panel 58 to act as a flap and contact the adhesive strip 42 when folded about fold line 44. In alternative embodiments, a flap structure can extend from the bottom panel, or the open end can be folded over twice to adhere the outer surface of the bottom panel to the adhesive.

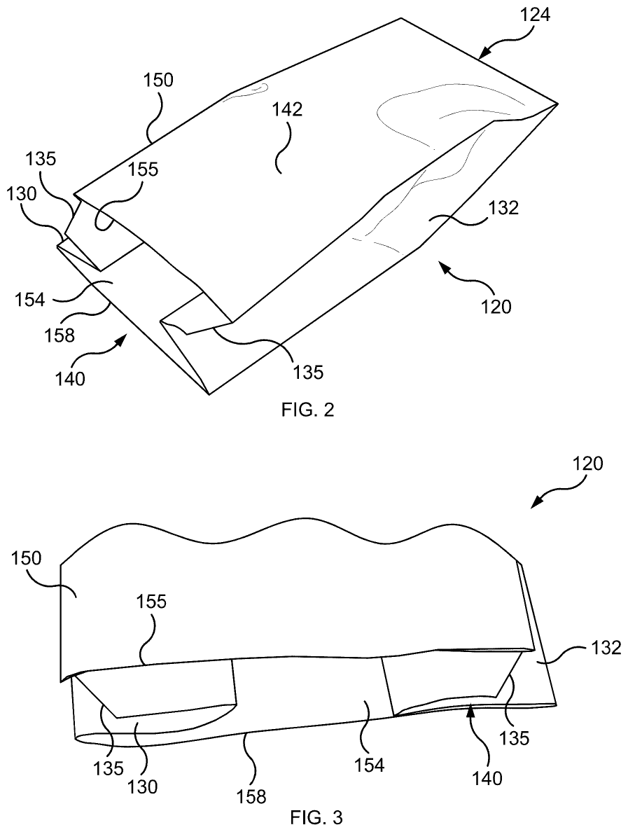

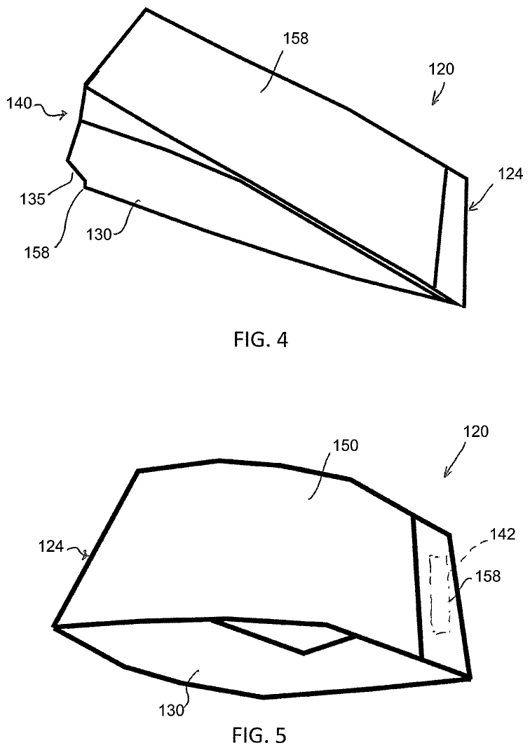

FIGS. 2-5 shows an alternative bag opening, according to one embodiment of the invention. The bag 120 includes similar components as discussed above for FIG. 1, with a different configuration for the open end 140. Here the top panel 150 is shorter than the bottom panel 158, with a straight line edge 155. The ends of the gusseted sides 130, 132, include angled portions 135 that extend from the offset edge 155 to the full length of the bottom panel 158. Again, a portion of the inner surface 154 of the bottom panel 158 is exposed, i.e., not covered by the top panel 150, to allow the inner surface 154 to contact the outer adhesive material 142 of the top panel 150 when folded. FIG. 3 shows a collapsed view of the open end 140. FIG. 4 shows the bottom panel 158 disposed upward, and showing the folded closed end 124. FIG. 5 shows a fully closed bag 120 enclosing a food item for cooking.

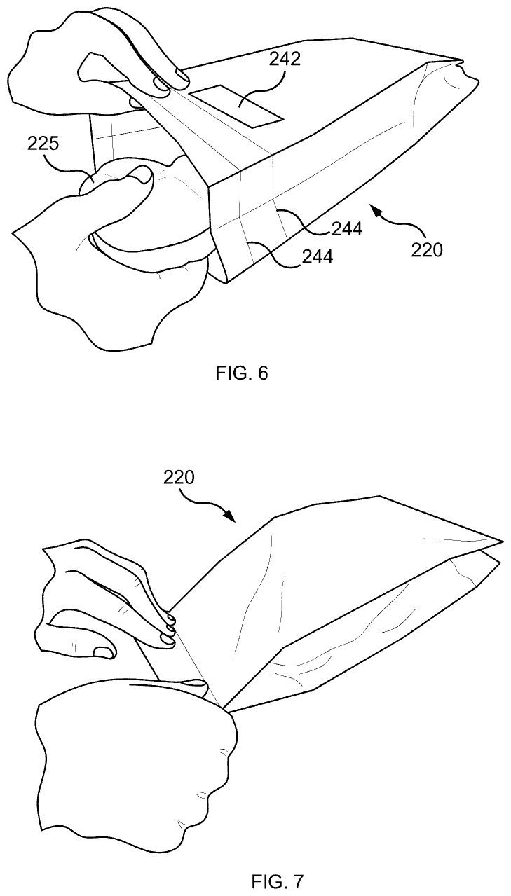

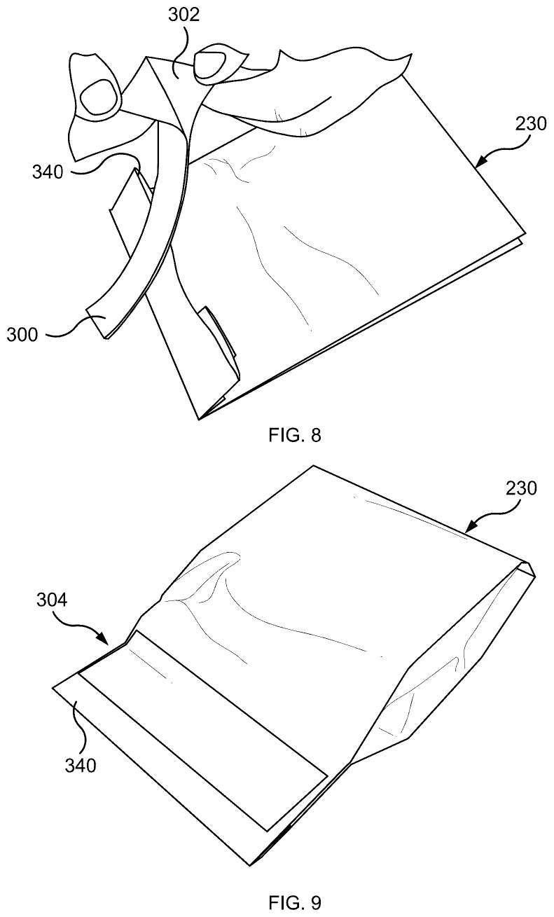

FIGS. 6 and 7 show a use of a bag 220 for receiving and holding food item 225 for cooking. The illustrated bag 220 includes no open end offset. The open end is closed onto adhesive 242 by a double fold-over, and as shown in FIG. 6 includes two sets of fold lines 244 for assisting with the double fold.

The adhesive material of embodiments of this invention is a heat settable acrylic adhesive, having a SAT rating of 600° F. The adhesive material is desirably printed on the bag side and dried, and the adhesive adheres the folded portion over the opening upon an application of pressure and heat. In other embodiments, the adhesive material is a pressure sensitive vinyl acetate adhesive, such as provided under a removeable liner strip. In some embodiments, the pressure sensitive adhesive strip is applied to the bag by a user when the food product is inserted into the paper bag. The adhesive can be activated by a press machine, such as a heated press.

FIGS. 8 and 9 illustrate an adhesive closure 300 according to another embodiment of this invention. The open end 340 of the bag 320 is folded back upon the bag 320, and a separate adhesive label 300 is removed from its liner 302 (FIG. 8) and placed over the intersection 304 of the folded open end 340 and the outer surface of the bag 320, as shown in FIG. 9. The label 300 can be any suitable temperature resistant label, such as without limitation using the paper and adhesive materials described herein (e.g., kraft paper with pressure sensitive adhesive). The labels can be provided on a reel for the end user, and avoid the need for a press machine described above. The labels can be printed as needed, such as with trademarks, directions of use, or any other desired information/text. Any label size, shape or configuration can be used, but desirably the label extends along approximately the full length of the bag to fully close the open end. The labels can further be used for other oven-safe containers.

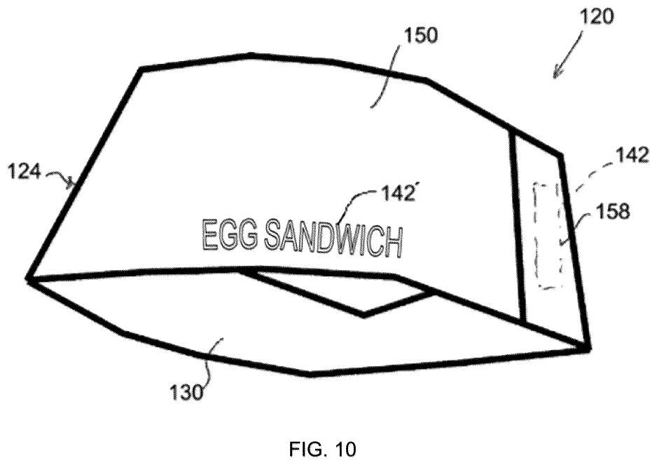

FIG. 10 shows an alternative bag 120 with an alternative or additional adhesive material application, according to embodiments of the invention. The bag 120 includes similar components as discussed above for FIG. 5. The adhesive material is cut into a label 142′ that is applied to the bag. The label 142′ can be any suitable identifier (e.g., alphanumeric serial/product number, UPC/QR code, and/or word descriptor) and/or logo, such as can be useful for identifying the contents of the closed bag 120. The label can be die cut from a strip of adhesive material 142 and applied as a heat resistant label 142′ to the bag 120.

Various and alternative configurations are available for the bag. In addition to alternatively side and shaped open ends or foldable flaps, the bags can be provided to the user in various configurations for storage and dispensing. For example, the folded bags can be connected along a line of weakening in a roll, for dispensing by tearing off each bag when needed.

Thus, the invention provides improvements to the design and materials for a paper-based food cooking bag.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A package for a food product to be cooked or warmed, the package comprising:
a paper bag formed of a transpiring paper material, the paper bag including an open end to receive the food product, wherein the open end configured to fold over and close the open end; and
a heat or pressure activated adhesive material on a side of the paper bag and configured to adhere to a folded portion of the paper bag, wherein the paper bag and the adhesive material are temperature resistant at cooking temperatures of over 520° F. (271° C.).

2. The package of claim 1, wherein the adhesive material is a heat settable acrylic adhesive, having a SAT rating of 600° F.

3. The package of claim 1, wherein the adhesive material is printed on the side and dried, and the adhesive adheres the folded portion over the opening upon an application of heat.

4. The package of claim 1, wherein the adhesive material is a pressure sensitive vinyl acetate adhesive.

5. The package of claim 4, wherein the pressure sensitive adhesive is applied by a user when the food product is inserted into the paper bag.

6. The package of claim 1, wherein the paper bag comprises a gusset fold longitudinally extending along each side panel.

7. The package of claim 1, wherein the paper material exhibits H₂O vapor permeability in a range of 5,000-15,000 cc H₂O/m²/about 24 h.

8. The package of claim 1, wherein the paper bag comprises fold lines along the opening to assist in folding and closing the open end.

9. The package of claim 1, wherein the paper material is non-transparent, and the paper bag comprises a transparent window configured to view the food product.

10. The package of claim 1, wherein the paper material comprises a moisture or grease resistant coating.

11. The package of claim 1, further comprising a label formed from the heat or pressure activated adhesive material.

12. The package of claim 2, wherein the adhesive material is printed on the side and dried, and the adhesive adheres the folded portion over the opening upon an application of heat.

13. The package of claim 12, wherein the adhesive material is a pressure sensitive vinyl acetate adhesive applied by a user when the food product is inserted into the paper bag.

14. The package of claim 12, wherein the paper bag comprises a gusset fold longitudinally extending along each side panel, and fold lines along the opening to assist in folding and closing the open end.

15. The package of claim 14, wherein the paper material exhibits H₂O vapor permeability in a range of 5,000-15,000 cc H₂O/m²/about 24 h.

16. The package of claim 14, wherein the paper material is non-transparent, and the paper bag comprises a transparent window configured to view the food product.

17. A packaged food preparation comprising a food item in the package according to claim 1.

18. Use of the package according to claim 1, to transport and cook food.

19. A continuous web of a plurality of packages each according to claim 1, wherein the plurality of packages are folded along a gusset side fold into a flattened orientation.

20. A method of cooking or warming a food item, the method comprising placing the food product packaged in the package of claim 1 into an electric oven or a microwave oven.
